(19) United States
(12) Patent Application Publication
(10) Pub. No.: US 2004/0133328 A1
(43) Pub. Date: Jul. 8, 2004

(54) Method of controlling the vehicle handling by means of influencing the control of the longitudinal lock for a fixed distribution of torques

(75) Inventors: Klaus Bastian, Neuhausen (DE); Jan Frank, Koeigsbach-Stein (DE); Markus Hofbauer, Rechberghausen (DE)

Correspondence Address: CROWELL & MORING LLP, INTELLECTUAL PROPERTY GROUP, P.O. BOX 14300, WASHINGTON, DC, 20044-4300, US

(73) Assignee: PORSCHE AG

(21) Appl. No.: 10/670,741

(22) Filed: Sep. 26, 2003

(30) Foreign Application Priority Data
Sep. 26, 2002 (DE) 102 45 033.1

(51) Int. Cl. G06F 19/00

(52) U.S. Cl. 701/67

(57) ABSTRACT

A function controls the longitudinal clutch which determines a compensation of different rotational wheel speeds on the left or right vehicle side and, as a function of a permissible difference value, sets a constant torque at the longitudinal clutch.

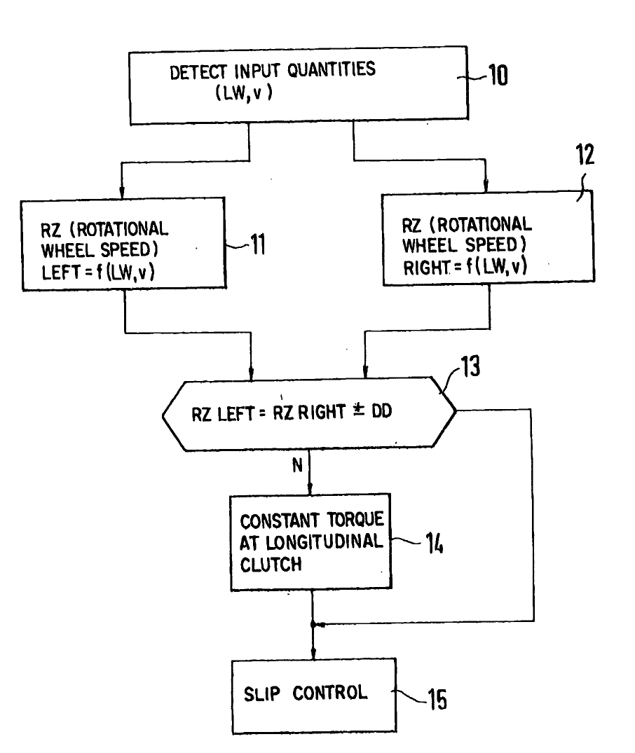

### BACKGROUND AND SUMMARY OF THE INVENTION

This application claims the priority of Application No. 102 45 033.1, filed Sep. 26, 2002, the disclosure of which is expressly incorporated by reference therein.

The present invention relates to a vehicle having a controllable longitudinal clutch for all-wheel systems for improving the control quality. Depending on the load condition, the torque distribution between the axles and the axle or wheel load, the wheels of the two vehicle sides may run at different speeds.

German Patent Document DE 198 30 561 C2 discloses a vehicle handling control for preventing a swerving and/or cross-wind deviation movement of a vehicle and particularly a vehicle handling control device. In the case of this known system, a selected wheel or several selected wheels are braked in a controlled manner in order to prevent a rise of the deviations of the rotational wheel speeds.

Furthermore, a method of influencing the yawing moments is known from European Patent Document EP 0 999 962 B1, in which dangerous situations may occur as a result of a cornering and a control braking on μ-split with a coefficient of friction which is lower on the outside of the curve than on the inside of the curve. Here, it is first determined whether a cornering is involved and which wheels, in this case, are on the inside of the curve or on the outside of the curve. As a result, this known method influences the yawing moment by a controlled braking of the front inside wheel.

For avoiding critical driving conditions, the present method according to the present invention intervenes in the controlling of a controllable longitudinal clutch. This method thereby improves the control quality in the case of vehicles with all-wheel drive. Here also, the rotational speed difference is first determined between the left and the right vehicle side, and the longitudinal lock is defined as a result of this comparison. By means of this measure, the control behavior of the slip control systems at the wheel can be stabilized in an advantageous manner. Furthermore, it is particularly advantageous that, for detecting the driving situation, sensors can be used which are already present and information can be exchanged between the control units in the vehicle by a bus system for determining the rotational wheel speeds, the driving speed and the curve radius as well as the driving torque. The control strategy according to the invention can be used for vehicles having an all-wheel drive with a longitudinal clutch, for a controllable all-wheel hang-on system and for a fixed distribution with a controllable longitudinal lock in the all-wheel transmission line.

Other objects, advantages and novel features of the present invention will become apparent from the following detailed description of the invention when considered in conjunction with the accompanying drawings.

### BRIEF DESCRIPTION OF THE DRAWING

An embodiment of the control according to the invention is illustrated in the figure and will be explained in detail in the following.

### DETAILED DESCRIPTION OF THE PREFERRED EMBODIMENT

The figure is a schematic flow chart for implementing the method. Only the important process steps are illustrated in the figure in order to thereby permit a simple and clear representation.

In a first operating step 10, various input quantities are detected for determining the driving situation, such as the steering angle LW and the speed v of the vehicle. Subsequently, in an operating step 11, the rotational wheel speed RZ for the left vehicle side RZleft is determined from the steering angle LW and speed v values. In parallel therewith, in an operating step 12, the rotational wheel speed for the right vehicle side RZright is determined. The rotational wheel speed RZ is a quantity derived from the steering angle LW and the speed v, so that the rotational wheel speed can essentially be described as a function of the steering angle and the speed, RZ=f(LW,v). The rotational wheel speed values determined for the right and left vehicle side are compared with one another in a subsequent step 13. When the rotational wheel speed of the left side of the vehicle RZleft deviates from the rotational wheel speed of the right side of the vehicle RZright by at least a definable rotational wheel speed difference DD, in operating step 14, a constant torque is first adjusted at the longitudinal clutch of the vehicle, so that constant distribution ratios between the axles will then exist for the other control systems for the slip control at the wheel. If the deviation is within a definable range DD (rotational speed difference), no action requirement will exist for adjusting the longitudinal clutch, and in the operating step 15, the, slip control is set which is determined by the control unit, and all additional control operations take place corresponding to the defined algorithms and standard values.

The presently described embodiment is used on an all-wheel vehicle with a fixed torque distribution and a controllable longitudinal lock. Depending on the driving speed and the steering angle, the function determines, by way of the rotational wheel speeds, the amount by which the wheel of one vehicle side on average deviate from the other vehicle side. If a maximally permissible amount is exceeded in this case, depending on the driving speed and the steering angle, the longitudinal lock is set to a constant value in order to provide constant distribution conditions for the slip control systems at the wheel. This clearly improves the control behavior at these systems.

The above-described function is designed for a straight-ahead driving of the vehicle. When a defined steering angle is exceeded, the function will not become operative because, during cornering, different path curves of the wheels occurs on the outside of the curve in comparison to those on the inside of the curve, and cause inaccuracies in the slip calculation. In order to avoid this problem, after the detection of a cornering according to a defined path curve model, the extent is determined by which the driving wheels on the inside of the curve rotate more slowly than the driving wheels on the outside of the curve. This value is now added as an offset to the permissible deviations DD for a straight-ahead drive. In this case, the preceding sign is taken into account because, during cornering, depending on the coefficient-of-friction conditions, driving wheels on the inside as well as on the outside of the curve may slip.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A method of controlling handling of a vehicle having a controllable longitudinal clutch for all-wheel systems, comprising the steps of:
separately determining rotational wheel speeds of each side of the vehicle by analyzing the rotational wheel speeds as a function of the driving speed and the steering angle;
comparing said determined wheel speeds on each side; and
setting a constant torque as a function of the driving speed and the steering angle when a difference between said determined wheel speeds on each side exceeds a definable rotational speed difference.

2. The method according to claim 1, wherein
the defineable rotational speed difference is stored in a characteristic diagram for any operating condition.

3. The method according to claim 1,
the steering angle is checked with respect to a cornering and, when a cornering is detected, an offset is determined which is added to the defineable rotational speed difference of the rotational wheel speeds.

4. The method according to claim 1, further including the step of setting a slip control.

5. The method according to claim 1 wherein the vehicle has a fixed torque distribution.

6. A method of controlling a vehicle, comprising the steps of:
determining a difference in speed between left side wheels and right side wheels of said vehicle; and
adjusting distribution ratios between axles of said vehicle as a function of said difference in speed.

7. The method according to claim 6, wherein said adjusting includes providing a constant torque at a longitudinal clutch when said difference in speed exceeds a predetermined value.

8. The method according to claim 6, further including the steps of setting a slip control as a function of said determining step.

9. The method according to claim 6, wherein said speed of left and right side wheels is determined as a function of a driving speed and a steering angle of said vehicle.
